(19) United States
(12) Patent Application Publication
(10) Pub. No.: US 2025/0216873 A1
(43) Pub. Date: Jul. 3, 2025

(54) FLOW RATE ADJUSTING DEVICE AND CONTROL METHOD OF FLOW RATE ADJUSTING DEVICE

(71) Applicant: Surpass Industry Co., Ltd., Gyoda-shi Saitama (JP)

(72) Inventor: Mizuho KOUCHI, Gyoda-shi Saitama (JP)

(73) Assignee: Surpass Industry Co., Ltd., Gyoda-shi Saitama (JP)

(21) Appl. No.: 18/978,250

(22) Filed: Dec. 12, 2024

(30) Foreign Application Priority Data
Dec. 27, 2023 (JP) 2023-221114

(51) Int. Cl. G05D 7/06; F16K 31/04; G01F 1/66; G01F 15/00

(52) U.S. Cl. CPC G05D 7/0635; F16K 31/046; G01F 1/662; G01F 15/005

(57) ABSTRACT

Provided is a flow rate adjusting device including: a flow metering portion; a flow rate adjusting portion; a flow rate setting unit; and a control unit. The flow rate adjusting portion has a stepping motor that moves a valve body along an axis and a motor driver that outputs excitation current to the stepping motor. The control unit controls the flow rate adjusting portion to move the valve body by an amount so that a measured flow rate value measured by the flow metering portion matches a set flow rate value, the amount corresponding to a difference between both the values, controls the motor driver to generate excitation current of a first current value during an operation to move the valve body, and controls the motor driver to generate excitation current of a second current value lower than the first current value during an operation to stop the valve body.

### CROSS-REFERENCE TO RELATED APPLICATIONS

This application claims foreign priority benefits under U.S.C. § 119 to Japanese Patent Application No. 2023-221114 filed on Dec. 27, 2023, the contents of which is hereby incorporated by reference in its entirety.

### BACKGROUND

### 1. Technical Field

The present disclosure relates to a flow rate adjusting device and a control method of a flow rate adjusting device.

### 2. Description of Related Art

Flow rate adjusting devices that includes a flow metering portion configured to measure the flow rate of a fluid and moves a valve body in a direction closer to or away from a valve hole to adjust the flow rate of a fluid passing through the valve hole so that the flow rate measured by the flow metering portion is a set flow rate set in advance are conventionally known (for example, Japanese Patent Application Laid-Open No. 2017-138200). As an electric drive portion for moving the valve body, for example, a stepping motor driven by a motor driver can be used.

When the valve body is moved by a stepping motor, a motor driver generates excitation current in accordance with a pulse signal received from a control unit and outputs the excitation current to the stepping motor. The motor driver can hold the drive shaft of the stepping motor at a predetermined position to prevent the rotation thereof by outputting excitation current to the stepping motor even when stopping the valve body without moving the same.

However, when excitation current of the same current value is output from the motor driver to the stepping motor in both cases where the valve body is moved by the stepping motor and where the valve body is stopped without being moved, the stepping motor and the motor driver will generate heat even when the valve body is stopped in the same manner as when the valve body is moved.

### BRIEF SUMMARY

The present disclosure has been made in view of such circumstances and intends to provide a flow rate adjusting device and a control method of a flow rate adjusting device that can suppress heat generation of a stepping motor and a motor driver during a stop operation to prevent motion of the valve body being performed.

The present disclosure employs the following solutions in order to solve the problem described above.

A flow rate adjusting device according to the first aspect of the present disclosure includes: a flow metering portion configured to measure a flow rate of a fluid flowing into a measurement flow channel from an inflow port and flowing through the measurement flow channel; a flow rate adjusting portion configured to move a valve body along an axis in a direction closer to or away from a valve hole to adjust a flow rate of a fluid flowing out from downstream of the measurement flow channel to an outflow port; a flow rate setting unit configured to set a set flow rate value of a fluid to be adjusted by the flow rate adjusting portion; and a control unit configured to control the flow rate adjusting portion and the flow rate setting unit. The flow rate adjusting portion has a stepping motor configured to rotate about the axis to move the valve body along the axis and a motor driver configured to generate excitation current used for driving the stepping motor and output the excitation current to the stepping motor. The control unit controls the flow rate adjusting portion to move the valve body by a motion amount so that a measured flow rate value of a fluid measured by the flow metering portion matches the set flow rate value, the motion amount being in accordance with a flow rate difference between the measured flow rate value and the set flow rate value, controls the motor driver to generate the excitation current of a first current value while performing a motion operation to move the valve body, and controls the motor driver to generate the excitation current of a second current value, which is lower than the first current value, while performing a stop operation to prevent motion of the valve body.

According to the flow rate adjusting device of the first aspect of the present disclosure, the control unit controls the flow rate adjusting portion to move the valve body by the motion amount so that the measured flow rate value of a fluid measured by the flow metering portion matches the set flow rate value, and the motion amount is in accordance with a flow rate difference between the measured flow rate value and the set flow rate value. Further, the control unit controls the motor driver to generate the excitation current of the first current value while performing a motion operation to move the valve body. On the other hand, the control unit controls the motor driver to generate the excitation current of the second current value, which is lower than the first current value, while performing a stop operation to prevent motion of the valve body.

According to the flow rate adjusting device of the first aspect of the present disclosure, the second current value of excitation current generated by the motor driver during the stop operation being performed is lower than the first current value of excitation current generated by the motor driver during the motion operation being performed. Thus, the heat generation of the stepping motor and the motor driver during the stop operation being performed can be suppressed compared to a case where, even during the stop operation being performed, the motor driver generates excitation current of the same first current value as that during the motion operation being performed.

The flow rate adjusting device according to the second aspect of the present disclosure further includes the following configuration in the first aspect. That is, the second current value is set to be 0.5 times or greater and 0.95 times or less of the first current value.

According to the flow rate adjusting device of the second aspect of the present disclosure, since the second current value is set to be 0.5 times or greater and 0.95 times or less of the first current value, the heat generation of the stepping motor and the motor driver during the stop operation being performed can be suitably suppressed.

The flow rate adjusting device according to the third aspect of the present disclosure further includes the following configuration in the first aspect. That is, the control unit performs the stop operation in a stop period from completion of a first motion operation of the motion operation to start of a second motion operation of the motion operation and sets a first stop period of the stop period when the flow rate difference is greater than a predetermined threshold and sets a second stop period of the stop period when the flow rate difference is less than or equal to the predetermined threshold, the second stop period being longer than the first stop period.

According to the flow rate adjusting device of the third aspect of the present disclosure, the second stop period applied when the flow rate difference is less than or equal to the predetermined threshold is longer than the first stop period applied when the flow rate difference is greater than the predetermined threshold. Thus, by applying a longer stop period in a state where the flow rate difference is less than or equal to the predetermined threshold and the variation of the flow rate is relatively small, it is possible to effectively suppress the heat generation of the stepping motor and the motor driver during the stop operation being performed. On the other hand, by applying a shorter stop period in a state where the flow rate difference is greater than the predetermined threshold and the variation of the flow rate is relatively large, it is possible to allow the flow rate difference to converge earlier.

The flow rate adjusting device according to the fourth aspect of the present disclosure further includes the following configuration in the third aspect. That is, the second stop period is set to be 1.1 times or longer and 20 times or shorter of the first stop period.

According to the flow rate adjusting device of the fourth aspect of the present disclosure, since the second stop period is set to be 1.1 times or longer and 20 times or shorter of the first stop period, the heat generation of the stepping motor and the motor driver when the flow rate difference is less than or equal to the predetermined threshold can be suitably suppressed.

The flow rate adjusting device according to the fifth aspect of the present disclosure further includes the following configuration in any one of the first aspect to the fourth aspect. That is, the flow rate adjusting device includes a temperature detecting portion configured to detect a temperature of the stepping motor or the motor driver, and when the temperature detected by the temperature detecting portion is less than a predetermined temperature value, the control unit controls the motor driver to generate the excitation current of the first current value while performing the motion operation, and when the temperature detected by the temperature detecting portion is greater than or equal to the predetermined temperature value, the control unit controls the motor driver to generate the excitation current of a third current value, which is lower than the first current value, while performing the motion operation.

According to the flow rate adjusting device of the fifth aspect of the present disclosure, when the temperature detected by the temperature detecting portion is less than the predetermined temperature value, it is possible to reliably hold the current position of the valve body by generating excitation current of the first current value during the motion operation being performed. On the other hand, when the temperature detected by the temperature detecting portion is greater than or equal to the predetermined temperature value, it is possible to suitably suppress the heat generation of the stepping motor and the motor driver by generating excitation current of the third current value, which is lower than the first current value during the motion operation being performed.

In a control method of a flow rate adjusting device according to the sixth aspect of the present disclosure, the flow rate adjusting device has a flow metering portion configured to measure a flow rate of a fluid flowing into a measurement flow channel from an inflow port and flowing through the measurement flow channel and a flow rate adjusting portion configured to move a valve body along an axis in a direction closer to or away from a valve hole to adjust a flow rate of a fluid flowing out from downstream of the measurement flow channel to an outflow port. The flow rate adjusting portion has a stepping motor configured to rotate about the axis to move the valve body along the axis and a motor driver configured to generate excitation current used for driving the stepping motor and output the excitation current to the stepping motor. The control method includes: a flow rate setting step of setting a set flow rate value of a fluid to be adjusted by the flow rate adjusting portion; and a control step of controlling the flow rate adjusting portion to move the valve body by a motion amount so that a measured flow rate value of a fluid measured by the flow metering portion matches the set flow rate value, the motion amount being in accordance with a flow rate difference between the measured flow rate value and the set flow rate value. The control step includes controlling the motor driver to generate the excitation current of a first current value while performing a motion operation to move the valve body and controlling the motor driver to generate the excitation current of a second current value, which is lower than the first current value, while performing a stop operation to prevent motion of the valve body.

According to the control method of the flow rate adjusting device of the sixth aspect of the present disclosure, the control step controls the flow rate adjusting portion to move the valve body by the motion amount so that the measured flow rate value of a fluid measured by the flow metering portion matches the set flow rate value, and the motion amount is in accordance with a flow rate difference between the measured flow rate value and the set flow rate value. Further, the control step controls the motor driver to generate the excitation current of the first current value while performing a motion operation to move the valve body. On the other hand, the control step controls the motor driver to generate the excitation current of the second current value, which is lower than the first current value, while performing a stop operation to prevent motion of the valve body.

According to the control method of the flow rate adjusting device of the sixth aspect of the present disclosure, the second current value of excitation current generated by the motor driver during the stop operation being performed is lower than the first current value of excitation current generated by the motor driver during the motion operation being performed. Thus, the heat generation of the stepping motor and the motor driver during the stop operation being performed can be suppressed compared to a case where, even during the stop operation being performed, the motor driver generates excitation current of the same first current value as that during the motion operation being performed.

According to the present disclosure, it is possible to provide a flow rate adjusting device and a control method of a flow rate adjusting device that can suppress the heat generation of a stepping motor and a motor driver during a stop operation to prevent motion of the valve body being performed.

### BRIEF DESCRIPTION OF THE SEVERAL VIEWS OF THE DRAWINGS

FIG. 1 is a partial longitudinal sectional view illustrating one embodiment of a flow rate adjusting device.

FIG. 2 is a partial longitudinal sectional view illustrating an ultrasonic flow metering portion illustrated in FIG. 1.

FIG. 3 is a partial longitudinal sectional view illustrating a flow rate adjusting portion and an outflow-side flow channel portion illustrated in FIG. 1.

FIG. 4 is a longitudinal sectional view illustrating an inflow-side flow channel portion and a pressure sensor illustrated in FIG. 1.

FIG. 5 is a block diagram illustrating a configuration of a control device.

FIG. 6 is a schematic configuration diagram illustrating a flow rate adjusting system in which the flow rate adjusting device is installed.

FIG. 7 is a flowchart illustrating a method of controlling a flow rate adjusting portion of the flow rate adjusting device of the present embodiment.

FIG. 8 is a graph illustrating an example of changes in the measured flow rate value of a fluid and changes in the opening of the valve body adjusted by the flow rate adjusting device of the present embodiment.

FIG. 9 is a graph illustrating an example of changes in the current value of excitation current output from a motor driver to a stepping motor of the flow rate adjusting device of the present embodiment.

FIG. 10 is a block diagram illustrating a configuration of a control device of a flow rate adjusting device of a modified example.

### DETAILED DESCRIPTION

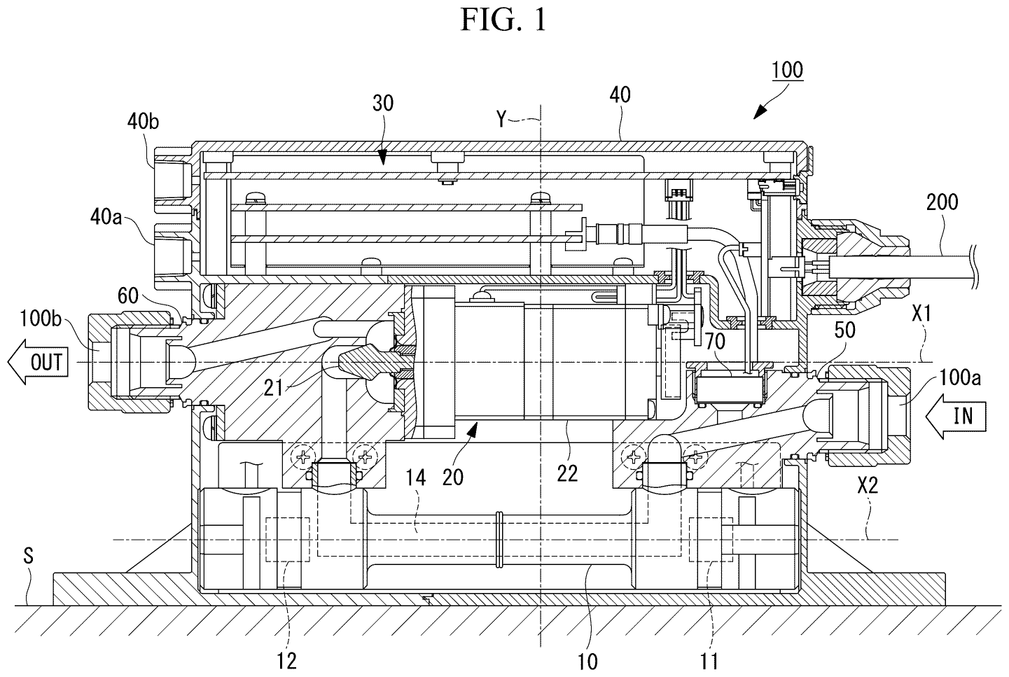

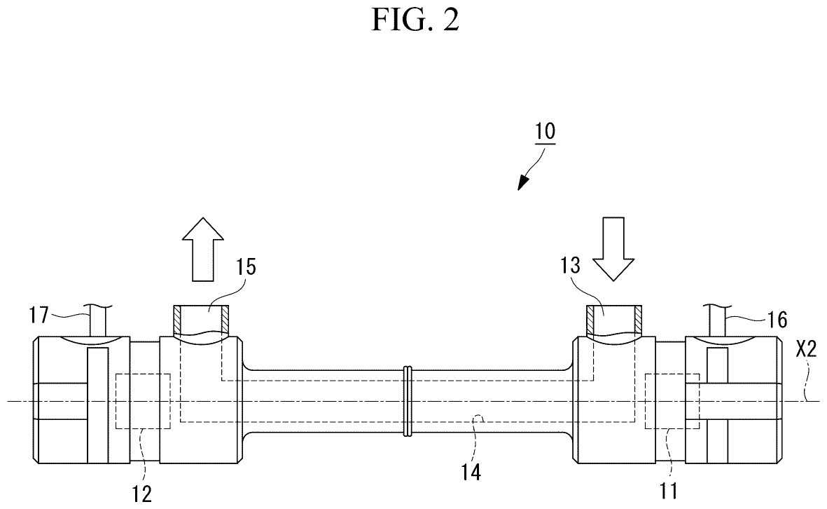

A flow rate adjusting device 100 of one embodiment of the present disclosure will be described below with reference to the drawings. FIG. 1 is a partial longitudinal sectional view illustrating one embodiment of the flow rate adjusting device 100. FIG. 2 is a partial longitudinal sectional view illustrating an ultrasonic flow metering portion illustrated in FIG. 1.

The flow rate adjusting device 100 of this embodiment shown in FIG. 1 includes: an ultrasonic flow metering portion 10 which measures a flow rate of a fluid flowing in from an inflow port 100a and circulated through a straight tube-shaped measurement flow channel 14; a flow rate adjusting portion 20 which adjusts the flow rate of the fluid; a control device 30 which controls the flow rate adjusting portion 20; a housing portion 40 which accommodates the ultrasonic flow metering portion 10, the flow rate adjusting portion 20, the control device 30; an inflow-side flow channel portion 50 which guides the fluid flowing in from the inflow port 100a to an upstream side of the measurement flow channel 14; an outflow-side flow channel portion 60 which guides the fluid flowing out from a downstream side of the measurement flow channel 14 to an outflow port 100b; a pressure sensor (pressure measuring portion) 70; and a temperature detecting portion 80.

The fluid whose flow rate is adjusted by the flow rate adjusting device 100 of this embodiment is, for example, a liquid such as a drug solution or pure water used for semiconductor manufacturing devices. The temperature of the fluid is, for example, a temperature in an ordinary temperature range (for example, 10° C. or higher and lower than 50° C.) or a high-temperature range (for example, 50° C. or higher and 80° C. or lower).

The housing portion 40 of the flow rate adjusting device 100 is fixed to an installation surface S with fastening bolts (not shown). The flow rate adjusting device 100 is connected to an external device (not shown) via a cable 200, is supplied with power from the external device via the cable 200, and transmits various signals to the external device and receives various signals therefrom.

Examples of the signals received from the external device include a signal indicating a set value of a target flow rate adjusted by the flow rate adjusting device 100. Examples of the signals transmitted to the external device include a signal indicating the flow rate of the fluid calculated by the control device 30 on the basis of s signal measured by the ultrasonic flow metering portion 10, and a signal indicating the pressure of the fluid measured by the pressure sensor 70.

The ultrasonic flow metering portion 10 measures a propagation time difference between ultrasonic waves transmitted by a pair of oscillators, i.e., an upstream side oscillator 11 disposed at the upstream side of the measurement flow channel 14 and a downstream side oscillator 12 disposed at the downstream side of the measurement flow channel 14, so as to obtain the flow rate of the fluid which flows in from an inflow-side pipe (not shown) and is circulated through the straight tube-shaped measurement flow channel 14.

As shown in FIG. 2, the ultrasonic flow metering portion 10 includes: the upstream side oscillator 11 and the downstream side oscillator 12 which are disposed on an axis line X2 that is parallel to the installation surface S; an inflow channel 13 which is connected to the inflow-side flow channel portion 50; the straight tube-shaped measurement flow channel 14 which is connected to the inflow channel 13 and extends along the axis line X2 (second axis line); and an outflow channel 15 which is connected to the outflow-side flow channel portion 60. The axis line X2 is parallel to an axis line X1 (first axis line) in which a valve body 21, which is described later, advances or recedes.

The upstream side oscillator 11 and the downstream side oscillator 12 are disposed at positions opposed to each other across the measurement flow channel 14 on the axis line X2, and can transmit and receive ultrasonic wave signals. The ultrasonic wave signal transmitted from the upstream side oscillator 11 propagates through the fluid circulated through the measurement flow channel 14 and is received by the downstream side oscillator 12.

Similarly, the ultrasonic wave signal transmitted from the downstream side oscillator 12 propagates through the fluid circulated through the measurement flow channel 14 and is received by the upstream side oscillator 11. Since the fluid is circulated through the measurement flow channel 14 from the upstream side to the downstream side, a propagation time for the ultrasonic wave signal transmitted from the upstream side oscillator 11 to the downstream side oscillator 12 is shorter than a propagation time for the ultrasonic wave signal transmitted from the downstream side oscillator 12 to the upstream side oscillator 11. The ultrasonic flow metering portion 10 measures the flow rate of the fluid circulated through the measurement flow channel 14 by using a difference between the propagation times.

Note that the transmission of the ultrasonic wave signals by the upstream side oscillator 11 and the downstream side oscillator 12 is controlled by the control device 30 which is connected to the upstream side oscillator 11 and the downstream side oscillator 12 with signal lines 16 and 17, respectively, which are shown in FIG. 2. The ultrasonic wave signals received by the upstream side oscillator 11 and the downstream side oscillator 12 are transmitted to the control device 30 via the signal lines 16 and 17. As described later, the control device 30 calculates a difference between propagation times from transmission timings for the ultrasonic wave signals that are sent as instructions to the upstream side oscillator 11 and the downstream side oscillator 12 and reception timings for the ultrasonic wave signals received from the upstream side oscillator 11 and the downstream side oscillator 12 according to the transmission timings, and also calculates the flow rate of the fluid from the calculated difference between propagation times.

The flow rate adjusting portion 20 adjusts the flow rate of the fluid flowing out to the outflow port 100b which is connected to an outflow-side pipe (not shown) via the outflow-side flow channel portion 60 from the downstream side of the measurement flow channel 14. As shown in FIG. 1, the flow rate adjusting portion 20 is disposed between the ultrasonic flow metering portion 10 and the control device 30 in an axis line Y direction corresponding to an installation direction orthogonal to the installation surface S. As shown in FIG. 1, in the axis line Y direction, the ultrasonic flow metering portion 10 is disposed at a position closest to the installation surface S, and the control device 30 is disposed at a position farthest from the installation surface S. The flow rate adjusting portion 20 is disposed between the ultrasonic flow metering portion 10 and the control device 30.

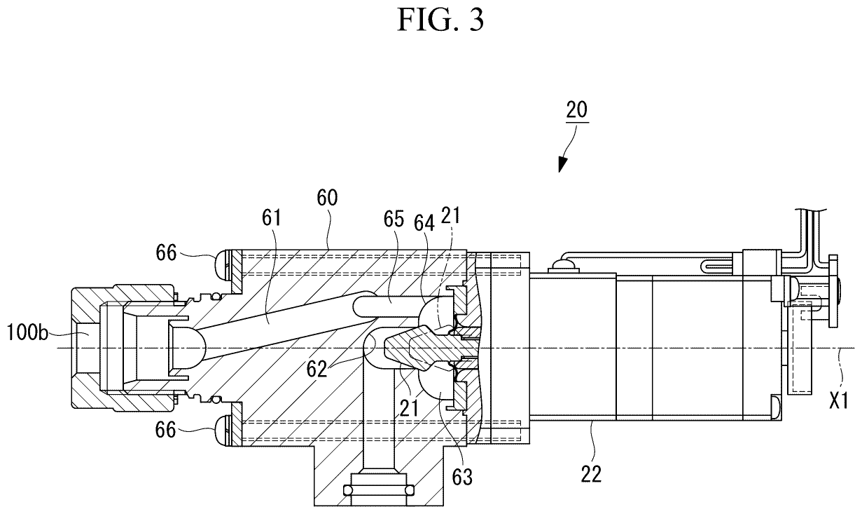

FIG. 3 is a partial longitudinal sectional view illustrating the flow rate adjusting portion 20 and the outflow-side flow channel portion 60 illustrated in FIG. 1. As illustrated in FIG. 3, the flow rate adjusting portion 20 has a valve body 21 inserted in a valve hole 62 formed in the outflow-side flow channel portion 60 and an electric drive portion 22 configured to move the valve body 21 in a direction closer to or away from the valve hole 62 along an axis X1 (first axis) parallel to the installation face S. The flow rate adjusting portion 20 moves the valve body 21 toward or away from the valve hole 62 along the axis X1 to adjust the flow rate of a fluid flowing out of the measurement flow channel 14.

The electric drive portion 22 moves the valve body 21 forward or backward along the axis X1 between a position of a closed state illustrated by the solid line in FIG. 3 and a position of an open state illustrated by the dashed line in FIG. 3. The flow rate adjusting portion 20 adjusts the amount of a fluid flowing into the valve chamber 63 from the valve hole 62 by adjusting the position of the valve body 21 on the axis X1 by the electric drive portion 22.

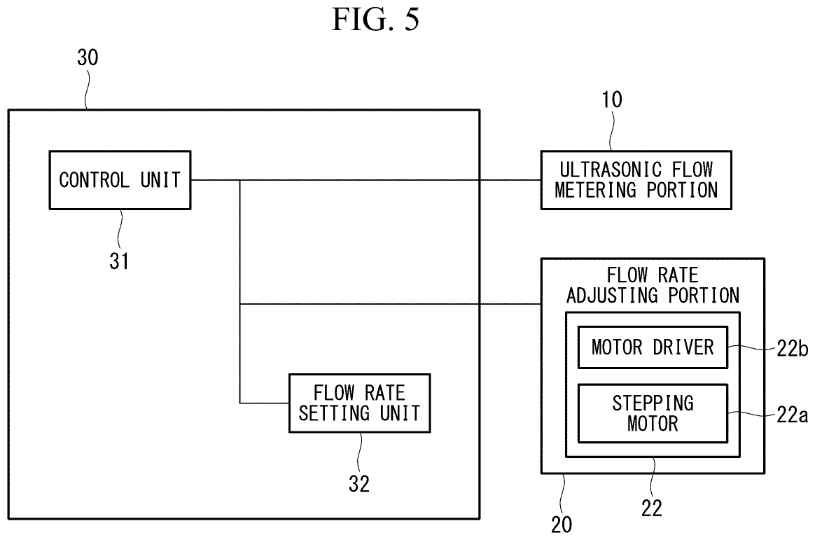

Herein, the configuration of the control device 30 will be described with reference to FIG. 5. FIG. 5 is a block diagram illustrating the configuration of the control device 30. As illustrated in FIG. 5, the control device 30 has a control unit 31 and a flow rate setting unit 32. The control unit 31 controls the ultrasonic flow metering portion 10, the flow rate adjusting portion 20, and the flow rate setting unit 32.

The control unit 31 controls the flow rate adjusting portion 20 based on a measured flow rate value FRac of a fluid measured by the ultrasonic flow metering portion 10. The control unit 31 controls the flow rate adjusting portion 20 to move the valve body 21 by a motion amount MV so that the measured flow rate value FRac of a fluid measured by the ultrasonic flow metering portion 10 matches a set flow rate value FRset set by the flow rate setting unit 32, and the motion amount MV is in accordance with a flow rate difference between the measured flow rate value FRac and the set flow rate value FRset.

The control unit 31 can instruct the upstream side oscillator 11 and the downstream side oscillator 12, respectively, which are included in the ultrasonic flow metering portion 10, to transmit ultrasonic wave signals. Further, the control unit 31 can detect a timing when the ultrasonic wave signal transmitted from one of the upstream side oscillator 11 and the downstream side oscillator 12 is received by the other one of the upstream side oscillator 11 and the downstream side oscillator 12.

The control unit 31 calculates a first propagation time from the transmission timing for the ultrasonic wave signal that is sent as an instruction to the downstream side oscillator 12 and the reception timing for the ultrasonic wave signal received by the upstream side oscillator 11 according to the transmission timing. Further, the control device 30 calculates a second propagation time from the transmission timing for the ultrasonic wave signal that is sent as an instruction to the upstream side oscillator 11 and the reception timing for the ultrasonic wave signal received by the downstream side oscillator 12 according to the transmission timing. The control unit 31 obtains the flow rate of the fluid circulated through the measurement flow channel 14 on the basis of a predetermined flow rate arithmetic expression and a propagation time difference obtained by subtracting the second propagation time from the first propagation time.

The flow rate setting unit 32 sets a set flow rate value FRset [ml/min] included in a flow rate range of the minimum flow rate, 0 [ml/min], to the maximum flow rate FRmax [ml/min] of the flow rate adjusting device 100. For example, the flow rate setting unit 32 sets the set flow rate value FRset based on a flow rate setting signal received by the control device 30 from an external device via the cable 200.

The electric drive portion 22 of the flow rate adjusting portion 20 has a stepping motor 22a that rotates about the axis X1 to move the valve body 21 along the axis X1 and a motor driver 22b that generates excitation current used for driving the stepping motor 22a and outputs the excitation current to the stepping motor 22a.

As indicated by an arrow in FIG. 1, the air introduced from the air introduction port 40a is circulated toward the inflow port 100a while cooling the lower surface of the control unit 31. After that, the air is circulated toward the outflow port 100b while cooling the upper surface of the control unit 31 and the upper and lower surfaces of the control unit 31, and is finally discharged from the air discharge port 40b.

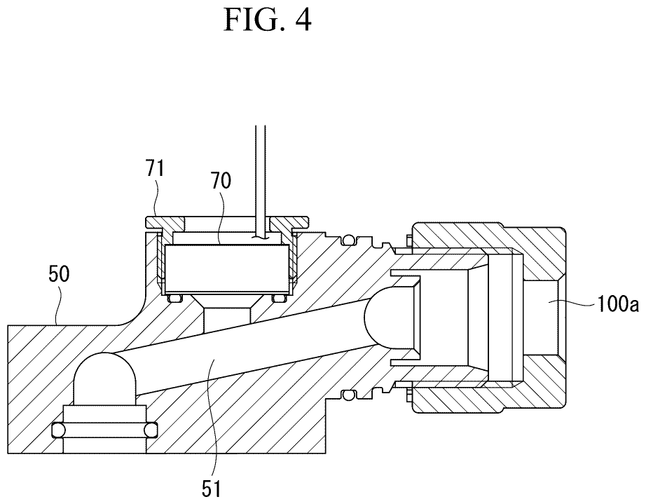

FIG. 4 is a longitudinal sectional view illustrating the inflow-side flow channel portion 50 and the pressure sensor 70 illustrated in FIG. 1. As shown in FIGS. 1 and 4, the inflow-side flow channel portion 50 is a member in which an inflow-side inclined flow channel 51 that is inclined in a direction approaching the installation surface S from the inflow port 100a to the upstream side inflow channel 13 of the measurement flow channel 14 is formed inside. The inflow-side flow channel portion 50 is provided with the pressure sensor 70 for detecting the pressure of the fluid circulated through the inflow-side inclined flow channel 51.

As shown in FIGS. 1 and 3, the outflow-side flow channel portion 60 is a member in which an outflow-side inclined flow channel 61 that is inclined in a direction approaching the installation surface S from the flow rate adjusting portion 20 to the outflow port 100b is formed inside. The outflow-side flow channel portion 60 guides the fluid to the upstream side of the outflow-side inclined flow channel 61 via an outflow channel 65 from an opening 64 that is formed at an upper portion of the valve chamber 63. The fluid guided to the upstream side of the outflow-side inclined flow channel 61 is further guided to the outflow port 100b along the outflow-side inclined flow channel 61. As shown in FIGS. 2 and 3, the outflow-side flow channel portion 60 is provided with through-holes through which a plurality of fastening bolts 66 penetrate. The outflow-side flow channel portion 60 is fixed to the electric driving portion 22 by fastening the fastening bolts 66 to the electric driving portion 22.

The pressure sensor 70 measures the pressure (supply pressure) of the fluid flowing into the inflow-side inclined flow channel 51 at the upstream side of the measurement flow channel 14 from the inflow port 100a. The pressure sensor 70 is, for example, a strain gauge pressure sensor. As shown in FIG. 4, the pressure sensor 70 is attached to the inflow-side flow channel portion 50 by a sensor holder 71. A pressure signal indicating the pressure of the fluid measured by the pressure sensor 70 is transmitted to the control device 30 and stored in a storage portion (not shown) included in the control device 30. The pressure signal is transmitted to the external device via the cable 200.

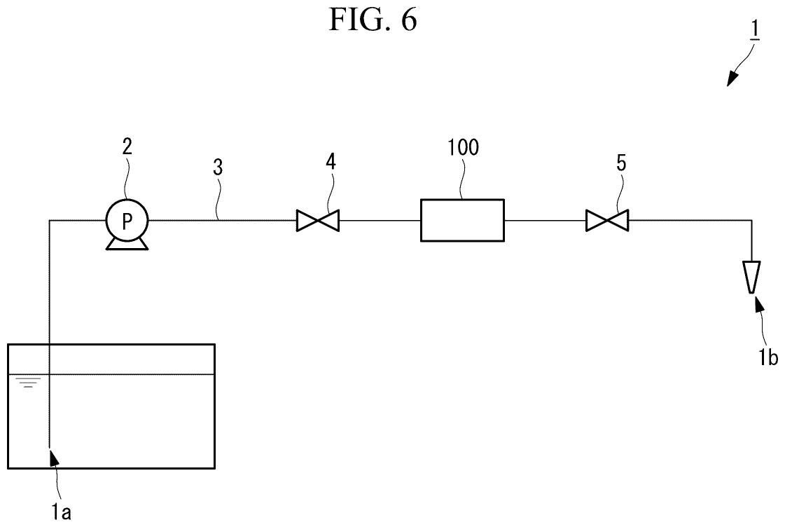

Next, a flow rate adjusting system 1 in which the flow rate adjusting device 100 of the present embodiment is installed will be described with reference to FIG. 6. FIG. 6 is a schematic configuration diagram illustrating the flow rate adjusting system 1 in which the flow rate adjusting device 100 is installed. As illustrated in FIG. 6, the flow rate adjusting system 1 has a pump 2 configured to pressurize and feed a fluid, a piping 3 configured to convey a fluid from an inflow end 1a to an outflow end 1b, the flow rate adjusting device 100, an on-off valve 4 arranged in the piping 3 upstream of the flow rate adjusting device 100, and an on-off valve 5 arranged in the piping 3 downstream of the flow rate adjusting device 100.

The flow rate adjusting system 1 causes the pump 2 to pressurize and feed a fluid flowing into the piping 3 from the inflow end 1a to supply the fluid to the flow rate adjusting device 100 and supplies the fluid with the flow rate adjusted by the flow rate adjusting device 100 to the outflow end 1b. A state where a fluid is supplied from the inflow end 1a to the flow rate adjusting device 100 and a state where no fluid is supplied from the inflow end 1a to the flow rate adjusting device 100 are switched therebetween by the on-off valve 4. A state where a fluid is supplied from the flow rate adjusting device 100 to the outflow end 1b and a state where no fluid is supplied from the flow rate adjusting device 100 to the outflow end 1b are switched therebetween by the on-off valve 5.

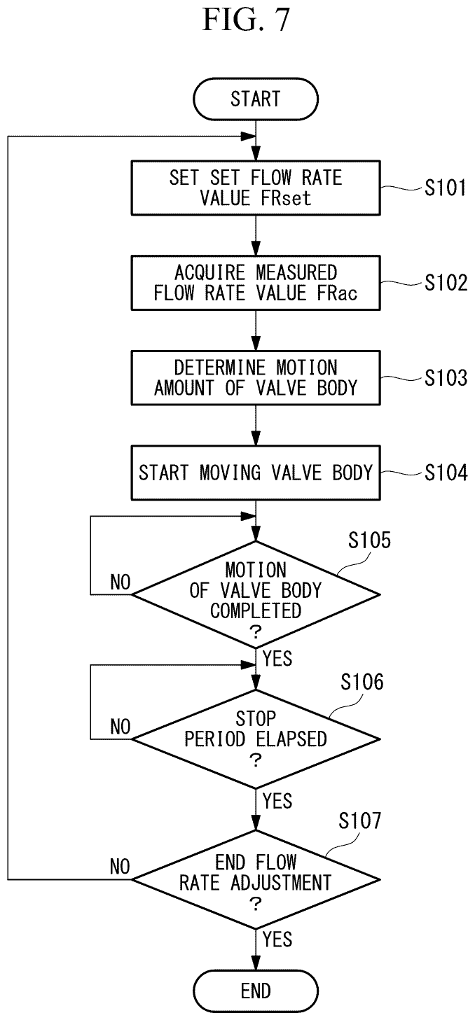

Next, the control method of the flow rate adjusting device 100 of the present embodiment will be described with reference to FIG. 7. FIG. 7 is a flowchart illustrating a method of controlling the flow rate adjusting portion 20 of the flow rate adjusting device 100 of the present embodiment. Each process illustrated in FIG. 7 is performed when the control device 30 executes a control program.

In step S101, the control unit 31 sets the set flow rate value FRset [ml/min] included in the flow rate range of the minimum flow rate, 0 [ml/min], to the maximum flow rate FRmax [ml/min] of the flow rate adjusting device 100. For example, the flow rate setting unit 32 sets the set flow rate value FRset based on a flow rate setting signal received by the control device 30 from an external device via the cable 200.

In step S102, the control unit 31 acquires the measured flow rate value FRac of a fluid flowing through the measurement flow channel 14 from the ultrasonic flow metering portion 10.

In step S103, the control unit 31 calculates the motion amount MV of the valve body 21 from the following equation (1):

MV=(FRset−FRac)×α (1),

where α is a coefficient of a positive value.

In step S104, the control unit 31 controls the flow rate adjusting portion 20 to start an operation to move the valve body 21 along the axis X1 by the motion amount MV determined in step S103.

If the measured flow rate value FRac is smaller than the set flow rate value FRset, the motion amount MV of the valve body 21 is a positive value. When the motion amount MV is a positive value, the control unit 31 moves the valve body 21 in a direction away from the valve hole 62 by the motion amount MV to increase the flow rate of the fluid passing through the valve hole 62.

In contrast, if the measured flow rate value FRac is greater than the set flow rate value FRset, the motion amount MV of the valve body 21 is a negative value. When the motion amount MV is a negative value, the control unit 31 moves the valve body 21 in a direction closer to the valve hole 62 by the motion amount MV to reduce the flow rate of the fluid passing through the valve hole 62.

In step S105, the control unit 31 determines whether or not the motion amount of the valve body 21 matches the motion amount MV determined in step S103 and the motion of the valve body 21 is thus completed and, if the determination is YES, proceeds with the process to step S106 or, if the determination is NO, again performs step S105. In response to the number of pulses of a pulse signal transmitted to the motor driver 22b reaching a predetermined number of pulses in accordance with the motion amount MV, the control unit 31 determines that the motion of the valve body 21 is completed.

In step S106, the control unit 31 determines whether or not a predetermined stop period has elapsed from the completion of the motion of the valve body 21 and, if the determination is YES, proceeds with the process to step S107 or, if the determination is NO, again performs step S106.

In step S107, the control unit 31 determines whether or not to end the flow rate adjustment of a fluid performed by the flow rate adjusting portion 20 and, if the determination is YES, ends the process of the present flowchart or, if the determination is NO, again performs step S101.

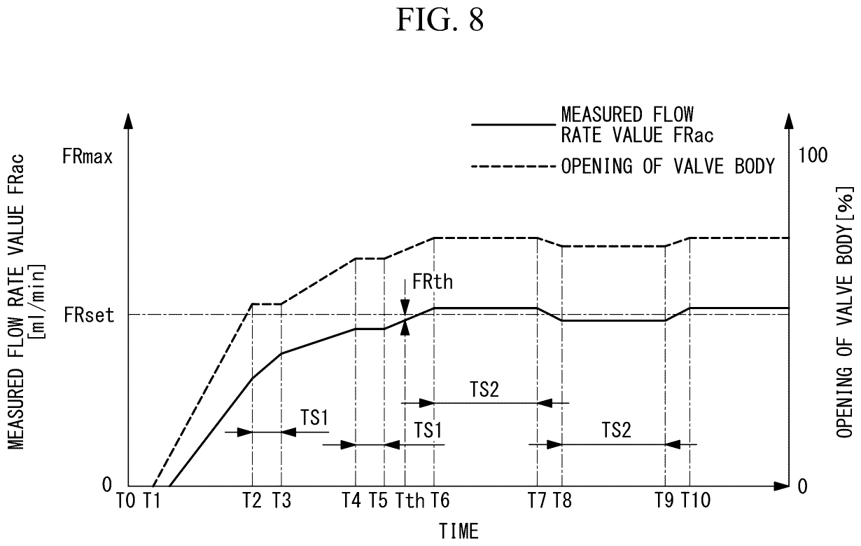

Next, an example of changes in the measured flow rate value FRac of a fluid and changes in the opening of the valve body 21 adjusted by the flow rate adjusting device 100 will be described with reference to FIG. 8. FIG. 8 is a graph illustrating an example of changes in the measured flow rate value FRac of a fluid and changes in the opening of the valve body 21 adjusted by the flow rate adjusting device 100 of the present embodiment.

As illustrated in FIG. 8, each period of time T1 to time T2, time T3 to time T4, time T5 to time T6, time T7 to time T8, and time T9 to time T10 is a period for performing the motion operation in which the valve body 21 is moved by the motion amount MV determined in step S103. On the other hand, each period of time T2 to time T3, time T4 to time T5, time T6 to time T7, and time T8 to time T9 is a period for performing the stop operation in which the valve body 21 is stopped without being moved.

In the example illustrated in FIG. 8, the valve body 21 starts being moved at time T1, the measured flow rate value FRac then gradually approaches the set flow rate value FRset, and the flow rate difference between the measured flow rate value FRac and the set flow rate value FRset matches the predetermined threshold FRth at time Tth. The flow rate difference between the measured flow rate value FRac and the set flow rate value FRset is larger than the predetermined threshold FRth in a period before time Tth, and the flow rate difference between the measured flow rate value FRac and the set flow rate value FRset is smaller than or equal to the predetermined threshold FRth in a period on and after time Tth.

As illustrated in FIG. 8, the control unit 31 performs the stop operation to stop the valve body 21 without moving the same in the stop period (for example, the period from time T2 to time T3) after completion of the first motion operation of the valve body 21 (for example, the motion operation from time T1 to time T2) and before start of the second motion operation (for example, the motion operation from time T3 to time T4).

As illustrated in FIG. 8, the control unit 31 sets the first stop period TS1 when the flow rate difference between the measured flow rate value FRac and the set flow rate value FRset is larger than the predetermined threshold FRth, and the control unit 31 sets the second stop period TS2, which is longer than the first stop period TS1, when the flow rate difference is smaller than or equal to the predetermined threshold FRth.

For example, the second stop period TS2 is set to be 1.1 times or longer and 20 times or shorter of the first stop period TS1. As described later, the second current value I2 output from the motor driver 22b to the stepping motor 22a in the second stop period TS2 is lower than the first current value I1 output from the motor driver 22b to the stepping motor 22a in the first stop period TS1. Thus, the longer the second stop period TS2 is than the first stop period TS1, the more the heat generation of the stepping motor 22a and the motor driver 22b can be suppressed.

On the other hand, the longer the second stop period TS2 is than the first stop period TS1, the longer the stop period of the valve body 21 will be, which results in a lower followability of the measured flow rate value FRac to the set flow rate value FRset. In setting the first stop period TS1 and the second stop period TS2, it is desirable to take both the suppression of heat generation of the stepping motor 22a and the motor driver 22b and the flowability of the measured flow rate value FRac to the set flow rate value FRset into consideration.

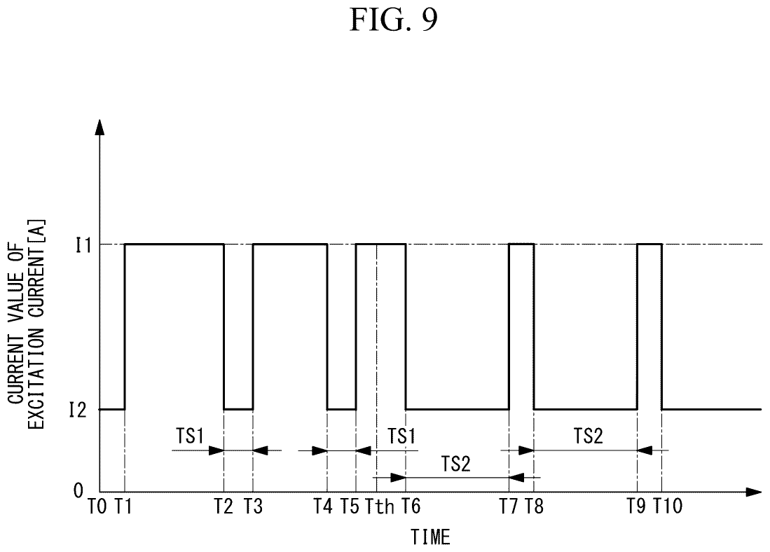

Next, an example of changes in the current value of excitation current output from the motor driver 22b to the stepping motor 22a of the flow rate adjusting device 100 of the present embodiment will be described. FIG. 9 is a graph illustrating an example of changes in the current value of excitation current output from the motor driver 22b to the stepping motor 22a of the flow rate adjusting device 100 of the present embodiment. Times T1 to T10 illustrated in FIG. 9 correspond to times T1 to T10 illustrated in FIG. 8.

As illustrated in FIG. 9, the control unit 31 controls the motor driver 22b to generate excitation current of the first current value I1 while performing a motion operation to move the valve body 21 (each period of time T1 to time T2, time T3 to time T4, time T5 to time T6, time T7 to time T8, and time T9 to time T10). Further, the control unit 31 controls the motor driver 22b to generate excitation current of the second current value I2, which is lower than the first current value I1, while performing a stop operation to prevent motion of the valve body 21 (each period of time T0 to time T1, time T2 to time T3, time T4 to time T5, time T6 to time T7, and time T8 to time T9).

The second current value I2 is set to be, for example, 0.5 times or greater and 0.95 times or less of the first current value I1. The second current value I2 output from the motor driver 22b to the stepping motor 22a in the second stop period TS2 is lower than the first current value I1 output from the motor driver 22b to the stepping motor 22a in the first stop period TS1. Thus, the lower the second current value I2 is than the first current value I1, the more the heat generation of the stepping motor 22a and the motor driver 22b can be suppressed.

On the other hand, the lower the second current value I2 is than the first current value I1, the smaller the torque required to hold a stop position of the valve body 21 will be. In setting the first current value I1 and the second current value I2, it is desirable to take both the suppression of heat generation of the stepping motor 22a and the motor driver 22b and the reduction in the torque required to hold a stop position of the valve body 21 into consideration.

The effects and advantages achieved by the flow rate adjusting device 100 of the present embodiment described above will be described.

According to the flow rate adjusting device 100 of the present embodiment, the control unit 31 controls the flow rate adjusting portion 20 to move the valve body 21 by the motion amount MV so that the measured flow rate value FRac of a fluid measured by the ultrasonic flow metering portion 10 matches the set flow rate value FRset, and the motion amount MV is in accordance with a flow rate difference between the measured flow rate value FRac and the set flow rate value FRset. Further, the control unit 31 controls the motor driver 22b to generate the excitation current of the first current value I1 while performing a motion operation to move the valve body 21. On the other hand, the control unit 31 controls the motor driver 22b to generate the excitation current of the second current value I2, which is lower than the first current value I1, while performing a stop operation to prevent motion of the valve body 21.

According to the flow rate adjusting device 100 of the present embodiment, the second current value I2 of excitation current generated by the motor driver 22b during the stop operation being performed is lower than the first current value I1 of excitation current generated by the motor driver 22b during the motion operation being performed. Thus, the heat generation of the stepping motor 22a and the motor driver 22b during the stop operation being performed can be suppressed compared to a case where, even during the stop operation being performed, the motor driver 22b generates excitation current of the same first current value I1 as that during the motion operation being performed.

According to the flow rate adjusting device 100 of the present embodiment, since the second current value I2 is set to be 0.5 times or greater and 0.95 times or less of the first current value I1, the heat generation of the stepping motor 22a and the motor driver 22b during the stop operation being performed can be suitably suppressed.

According to the flow rate adjusting device 100 of the present embodiment, the second stop period TS2 applied when the flow rate difference between the measured flow rate value FRac and the set flow rate value FRset is less than or equal to the predetermined threshold FRth is longer than the first stop period TS1 applied when the flow rate difference is greater than the predetermined threshold FRth. Thus, by applying a longer stop period in a state where the flow rate difference is less than or equal to the predetermined threshold FRth and the variation of the flow rate is relatively small, it is possible to effectively suppress the heat generation of the stepping motor 22a and the motor driver 22b during the stop operation being performed. On the other hand, by applying a shorter stop period in a state where the flow rate difference is greater than the predetermined threshold FRth and the variation of the flow rate is relatively large, it is possible to allow the flow rate difference to converge earlier.

Further, according to the flow rate adjusting device 100 of the present embodiment, since the second stop period TS2 is set to be 1.1 times or longer and 20 times or shorter of the first stop period TS1, the heat generation of the stepping motor 22a and the motor driver 22b when the flow rate difference is less than or equal to the predetermined threshold FRth can be suitably suppressed.

### Other Embodiments

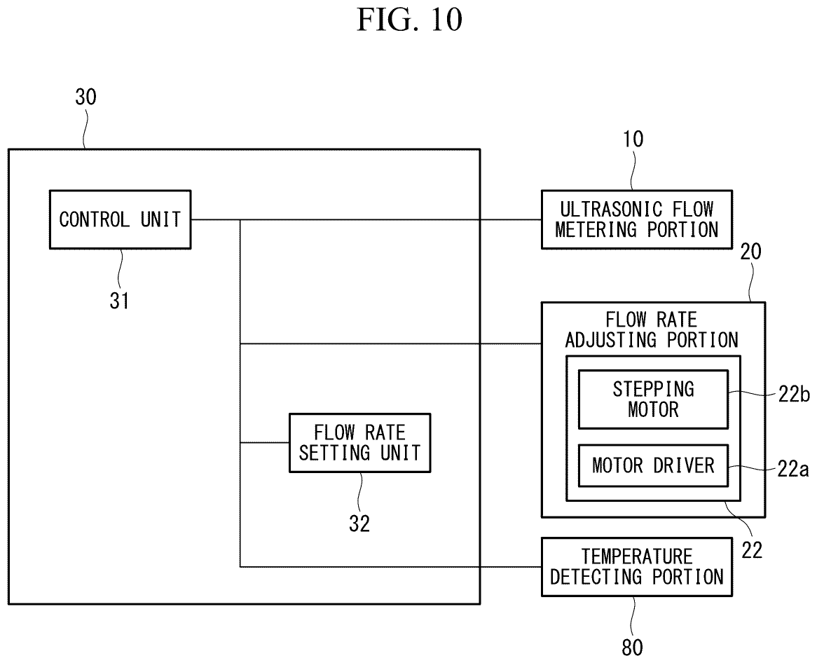

The flow rate adjusting device 100 described above may be embodied as a modified example including a temperature detecting portion 80 configured to detect the temperature of the stepping motor 22a or the motor driver 22b. FIG. 10 is a block diagram illustrating the configuration of the control device 30 of the flow rate adjusting device 100 of the modified example. As illustrated in FIG. 10, the flow rate adjusting device 100 of the modified example includes the temperature detecting portion 80 configured to detect the temperature of the stepping motor 22a or the motor driver 22b and transfer the detected temperature to the control unit 31.

The control unit 31 of the modified example controls the motor driver 22b to generate excitation current of the first current value I1 while performing the motion operation when the temperature detected by the temperature detecting portion 80 is less than the predetermined temperature value, and the control unit 31 controls the motor driver 22b to generate excitation current of a third current value I3, which is lower than the first current value I1, while performing the stop operation when the temperature detected by the temperature detecting portion 80 is greater than or equal to the predetermined temperature value. The third current value I3 is set to any value in a range of 50% or greater and 80% or less of the first current value I1, for example.

According to the flow rate adjusting device 100 of the present modified example, when the temperature detected by the temperature detecting portion 80 is less than the predetermined temperature value, it is possible to reliably hold the current position of the valve body 21 by generating excitation current of the first current value I1 during the motion operation being performed. On the other hand, when the temperature detected by the temperature detecting portion 80 is greater than or equal to the predetermined temperature value, it is possible to suitably suppress the heat generation of the stepping motor 22a and the motor driver 22b by generating excitation current of the third current value I3, which is lower than the first current value I1, during the motion operation being performed. Further, by generating the excitation current of the third current value I3 lower than the first current value I1, it is possible to reduce the power consumption of the stepping motor 22a and the motor driver 22b.

In the flow rate adjusting device 100 of the modified example above, the temperature detecting portion 80 may be provided inside the motor driver 22b. In such a case, status information indicating the temperature of the motor driver 22b is transferred to the control unit 31 from the motor driver 22b. When the status information transferred from the motor driver 22b indicates that the temperature is less than the predetermined temperature value, the control unit 31 controls the motor driver 22b to generate excitation current of the first current value I1 while performing the motion operation. On the other hand, when the status information transferred from the motor driver 22b indicates that the temperature is greater than or equal to the predetermined temperature value, the control unit 31 controls the motor driver 22b to generate excitation current of the third current value I3 while performing the motion operation.

Although the flow rate adjusting device 100 accommodates the ultrasonic flow metering portion 10 and the flow rate adjusting portion 20 in the same casing (the housing portion 40) in the above description, other forms may be employed. For example, the flow rate adjusting device 100 may accommodate the ultrasonic flow metering portion 10 in a separate casing from other configurations including the flow rate adjusting portion 20. It is preferable to transfer a flow rate of a fluid measured by the ultrasonic flow metering portion 10 to the control device 30 of the flow rate adjusting device 100 via a cable (not illustrated).

Although the flow rate adjusting device 100 measures the flow rate of a fluid by using the ultrasonic flow metering portion 10 in the above description, other forms may be employed. For example, a flow rate may be measured by other systems such as a differential pressure flow metering portion that measures the flow rate of a fluid based on a fluid pressure difference at two locations.

What is claimed is:

1. A flow rate adjusting device comprising:
a flow metering portion configured to measure a flow rate of a fluid flowing through a measurement flow channel;
a flow rate adjusting portion configured to move a valve body along an axis in a direction closer to or away from a valve hole to adjust a flow rate of a fluid flowing out of the measurement flow channel;
a flow rate setting unit configured to set a set flow rate value of a fluid to be adjusted by the flow rate adjusting portion; and
a control unit configured to control the flow rate adjusting portion and the flow rate setting unit,
wherein the flow rate adjusting portion includes
a stepping motor configured to rotate about the axis to move the valve body along the axis, and
a motor driver configured to generate excitation current used for driving the stepping motor and output the excitation current to the stepping motor, and
wherein the control unit is configured to
control the flow rate adjusting portion to move the valve body by a motion amount so that a measured flow rate value of a fluid measured by the flow metering portion matches the set flow rate value, the motion amount being in accordance with a flow rate difference between the measured flow rate value and the set flow rate value,
control the motor driver to generate the excitation current of a first current value while performing a motion operation to move the valve body, and
control the motor driver to generate the excitation current of a second current value, which is lower than the first current value, while performing a stop operation to prevent motion of the valve body.

2. The flow rate adjusting device according to claim 1, wherein the second current value is set to be 0.5 times or greater and 0.95 times or less of the first current value.

3. The flow rate adjusting device according to claim 1, wherein the control unit is configured to
perform the stop operation in a stop period from completion of a first motion operation of the motion operation to start of a second motion operation of the motion operation, and
set a first stop period of the stop period when the flow rate difference is greater than a predetermined threshold and sets a second stop period of the stop period when the flow rate difference is less than or equal to the predetermined threshold, the second stop period being longer than the first stop period.

4. The flow rate adjusting device according to claim 3, wherein the second stop period is set to be 1.1 times or longer and 20 times or shorter of the first stop period.

5. The flow rate adjusting device according to claim 1 further comprising a temperature detecting portion configured to detect a temperature of the stepping motor or the motor driver,
wherein when the temperature detected by the temperature detecting portion is less than a predetermined temperature value, the control unit controls the motor driver to generate the excitation current of the first current value while performing the motion operation, and when the temperature detected by the temperature detecting portion is greater than or equal to the predetermined temperature value, the control unit controls the motor driver to generate the excitation current of a third current value, which is lower than the first current value, while performing the motion operation.

6. A control method of a flow rate adjusting device,
wherein the flow rate adjusting device includes
a flow metering portion configured to measure a flow rate of a fluid flowing into a measurement flow channel from an inflow port and flowing through the measurement flow channel, and
a flow rate adjusting portion configured to move a valve body along an axis in a direction closer to or away from a valve hole to adjust a flow rate of a fluid flowing out from downstream of the measurement flow channel to an outflow port,
wherein the flow rate adjusting portion includes
a stepping motor configured to rotate about the axis to move the valve body along the axis, and
a motor driver configured to generate excitation current used for driving the stepping motor and output the excitation current to the stepping motor,
the control method comprising:
a flow rate setting step of setting a set flow rate value of a fluid to be adjusted by the flow rate adjusting portion; and
a control step of controlling the flow rate adjusting portion to move the valve body by a motion amount so that a measured flow rate value of a fluid measured by the flow metering portion matches the set flow rate value, the motion amount being in accordance with a flow rate difference between the measured flow rate value and the set flow rate value,
wherein the control step includes
controlling the motor driver to generate the excitation current of a first current value while performing a motion operation to move the valve body, and
controlling the motor driver to generate the excitation current of a second current value, which is lower than the first current value, while performing a stop operation to prevent motion of the valve body.
